(19) United States
(12) Patent Application Publication
(10) Pub. No.: US 2019/0023409 A1
(43) Pub. Date: Jan. 24, 2019

(54) SYSTEM FOR PREVENTING EXHAUST GAS IMPINGEMENT ON AIRCRAFT SURFACES AND SURROUNDING AREAS

(71) Applicant: Sikorsky Aircraft Corporation, Stratford, CT (US)

(72) Inventors: Joseph L. Simonetti, Southbury, CT (US); Michael Kazlauskas, Watertown, CT (US); Shyam Neerarambam, Shelton, CT (US)

(21) Appl. No.: 15/655,184

(22) Filed: Jul. 20, 2017

(51) Int. Cl. B64D 33/04; F01D 25/30; B64D 27/20

(52) U.S. Cl. CPC B64D 33/04; F05D 2220/50; B64D 27/20; F01D 25/30

(57) ABSTRACT

An aircraft including a fuselage having one or more surfaces. At least one engine is mounted in the fuselage. The at least one engine includes an exhaust outlet. A high velocity jet is arranged at the fuselage forward of the exhaust outlet. The high velocity jet is positioned to direct a stream of high velocity gases toward the exhaust outlet redirecting exhaust gases from the one or more surfaces.

### STATEMENT OF FEDERAL SUPPORT

This invention was made with Government support under N00019-14-C-0050 awarded by the United States Department of the Navy. The Government has certain rights in the invention.

### BACKGROUND

Exemplary embodiments pertain to the art of aircraft and, more particularly, to a system for preventing exhaust gas impingement on aircraft surfaces and surrounding areas.

During engine operation, hot exhaust gases may impinge upon airframe surfaces. Hot exhaust gases from an auxiliary power unit (APU) or an engine of the aircraft may leave an exhaust outlet and be directed onto or over one or more surfaces of the aircraft. The hot gases may also be directed to other incidental areas around the aircraft such as areas accessed by ground personnel. Various systems have been proposed to redirect the hot exhaust gases. Nozzling, e.g., exhaust gas vectoring, and changes in duct geometry have been employed to redirect hot exhaust gases. Exhaust gas vectoring adds significant complexity to the aircraft design. Exhaust ducting introduces additional installed engine performance penalties.

### BRIEF DESCRIPTION

Disclosed is an aircraft including a fuselage having one or more surfaces. At least one engine is mounted in the fuselage. The at least one engine includes an exhaust outlet. A high velocity jet is arranged at the fuselage forward of the exhaust outlet. The high velocity jet is positioned to direct a stream of high velocity gases toward the exhaust outlet redirecting exhaust gases from the one or more surfaces.

In addition to one or more of the features described above or below, or as an alternative, further embodiments could include wherein the stream of high velocity gases comprises a jet of exhaust gases having one of a transonic velocity and a supersonic velocity.

In addition to one or more of the features described above or below, or as an alternative, further embodiments could include wherein the at least one engine includes a first engine having a first exhaust outlet and a second engine having a second exhaust outlet.

In addition to one or more of the features described above or below, or as an alternative, further embodiments could include wherein the high velocity jet is arranged forward of and below the first exhaust outlet and forward of the second exhaust outlet.

In addition to one or more of the features described above or below, or as an alternative, further embodiments could include wherein the second engine comprises an auxiliary power unit (APU) and the second exhaust outlet comprises an APU exhaust outlet.

In addition to one or more of the features described above or below, or as an alternative, further embodiments could include wherein the APU includes a compressor portion, the high velocity jet being fluidically connected to the compressor portion.

In addition to one or more of the features described above or below, or as an alternative, further embodiments could include wherein the high velocity jet includes a selectively positionable outlet configured to selectively adjust a direction of the stream of high velocity gases.

Also disclosed is a method of redirecting exhaust gases passing from at least one engine of an aircraft including directing a flow of high velocity gases to a high velocity jet supported at a fuselage of the aircraft forward of an exhaust outlet of the at least one engine, guiding the flow of high velocity gases from the high velocity jet toward the exhaust gases passing from the exhaust outlet of the at least one engine, and redirecting the exhaust gases away from surfaces of the fuselage with the flow of high velocity gases.

In addition to one or more of the features described above or below, or as an alternative, further embodiments could include generating the flow of high velocity gases in the aircraft.

In addition to one or more of the features described above or below, or as an alternative, further embodiments could include wherein generating the flow of high velocity gases in the aircraft includes operating an auxiliary power unit (APU) compressor.

In addition to one or more of the features described above or below, or as an alternative, further embodiments could include wherein directing the flow of high velocity gases toward the exhaust outlet includes guiding the exhaust gases from the high velocity jet toward a first exhaust outlet and a second exhaust outlet.

In addition to one or more of the features described above or below, or as an alternative, further embodiments could include wherein guiding the flow of high velocity gases toward the first exhaust outlet and the second exhaust outlet includes guiding the flow of high velocity gases toward a main engine exhaust outlet and an auxiliary power unit (APU) exhaust outlet.

In addition to one or more of the features described above or below, or as an alternative, further embodiments could include wherein guiding the flow of high velocity gases includes directing the flow of high velocity gases upwardly toward the main engine exhaust outlet and rearwardly toward the APU exhaust outlet.

In addition to one or more of the features described above or below, or as an alternative, further embodiments could include selectively repositioning an outlet of the high velocity jet.

In addition to one or more of the features described above or below, or as an alternative, further embodiments could include wherein directing the flow of high velocity gases to the high velocity jet includes directing a flow of gases having one of a transonic velocity and a high velocity gases toward the high velocity jet.

### BRIEF DESCRIPTION OF THE DRAWINGS

The following descriptions should not be considered limiting in any way. With reference to the accompanying drawings, like elements are numbered alike:

FIG. 1 depicts a rotary wing aircraft including a system for redirecting exhaust gases, in accordance with an exemplary embodiment;

FIG. 2 depicts an exhaust outlet and auxiliary power unit (APU) outlet of the aircraft of FIG. 1;

FIG. 3 depicts a gas jet discharge nozzle for redirecting exhaust gases from one or more of the exhaust outlet and the APU outlet, in accordance with an exemplary embodiment; and

FIG. 4 depicts a block diagram illustrating a gas jet source for the gas jet nozzle of FIG. 3, in accordance with an aspect of an exemplary embodiment.

### DETAILED DESCRIPTION

A detailed description of one or more embodiments of the disclosed apparatus and method are presented herein by way of exemplification and not limitation with reference to the Figures.

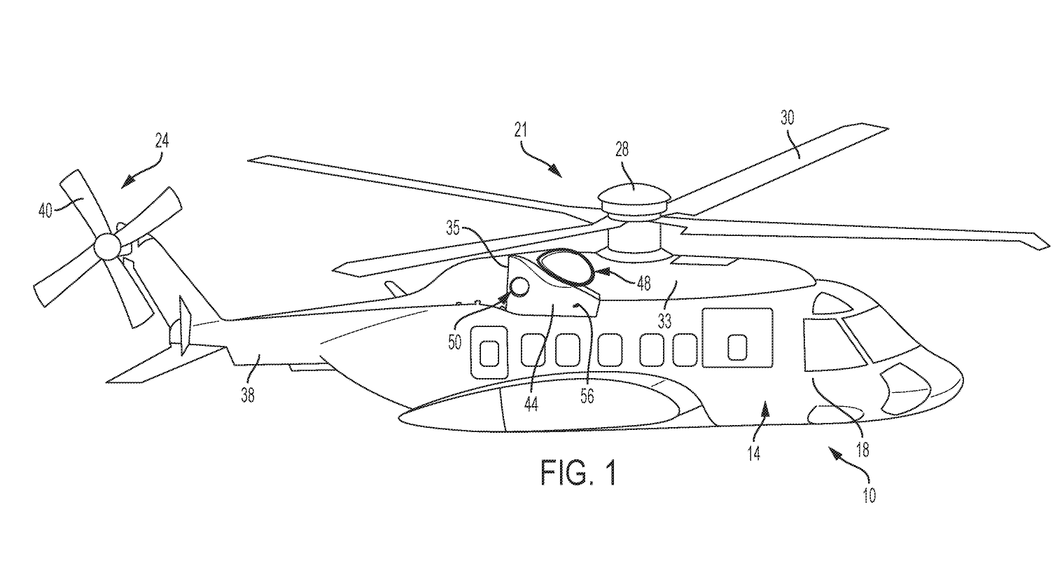

An aircraft, in accordance with an exemplary embodiment, is indicated generally at 10 in FIG. 1. While shown as a vertical take-off and landing (VTOL) or rotary wing aircraft 14, it should be understood that aircraft 10 may take on a variety of forms including fixed wing aircraft. Aircraft 10 includes a fuselage 18 that supports a main rotor system 21 and a tail rotor system 24. Main rotor system 21 includes a rotor hub 28 that supports a plurality of rotor blades 30. While shown as a single rotor system, it should be understood that main rotor system 21 may comprise a dual rotor system.

Aircraft 10 includes a main engine 33 operatively connected to a gear box 35 which, in turn, is mechanically linked to main rotor system 21. Aircraft 10 is further shown to include an extending tail 38 that supports a plurality of tail rotor blades 40 of tail rotor system 24. In an exemplary embodiment, tail rotor system 24 provides yaw control for aircraft 10. However, it is to be understood that tail rotor system 24 may also be arranged to provide forward thrust. Aircraft 10 is also shown to include an auxiliary power unit 44 (APU) that may be selectively operated to provide power to functions not related to propulsion.

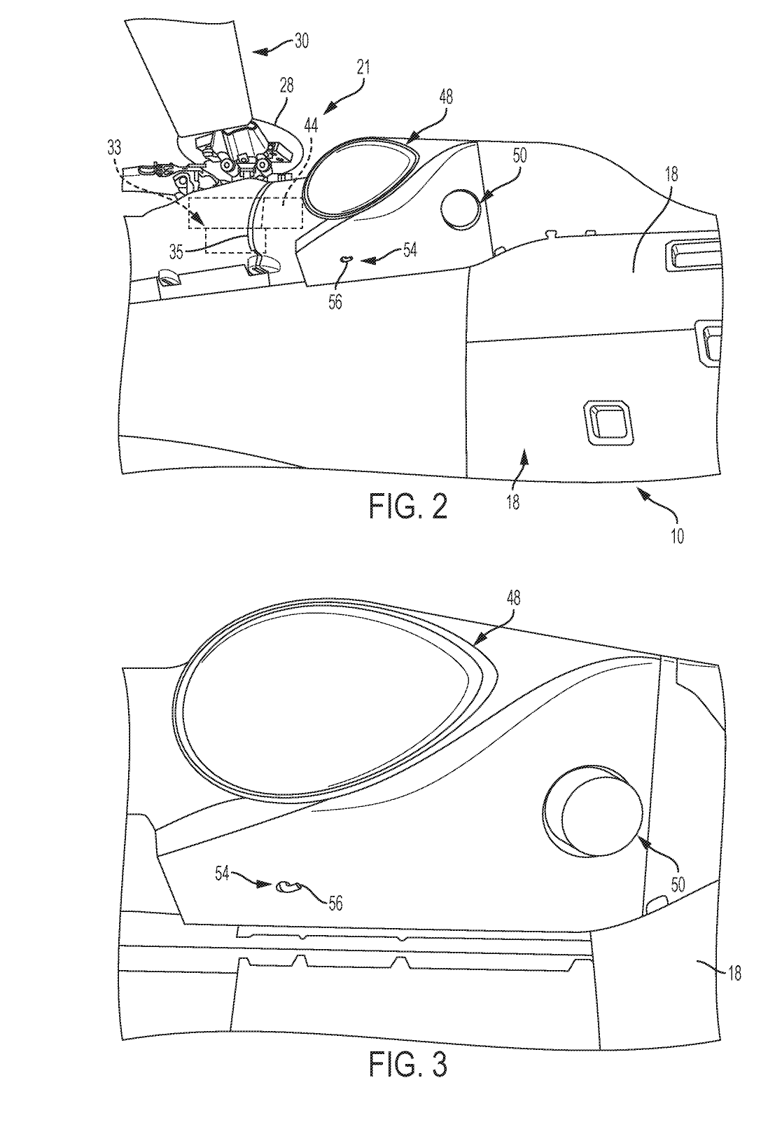

As shown in FIGS. 2-3, main engine 33 includes a main engine exhaust outlet 48 and APU 44, which includes an APU exhaust outlet 50 arranged on fuselage 18 below and aft of main rotor system 21. In the exemplary embodiment shown, APU exhaust outlet 50 is arranged below and aft relative to main engine exhaust outlet 48. Main engine exhaust outlet 48 and APU exhaust outlet 50 may direct hot exhaust gases onto surfaces of fuselage 18 and areas surrounding aircraft 10. Hot gas impingement on aircraft surfaces may cause damage.

In accordance with an aspect of an exemplary embodiment, aircraft 10 includes a high velocity jet 54 having an outlet nozzle 56 arranged proximate to main engine exhaust outlet 48 and APU exhaust outlet 50. In an example, outlet nozzle 56 is arranged forward of and below main engine exhaust outlet 48 and forward of APU exhaust outlet 50. Outlet nozzle 56 may also be arranged below APU exhaust outlet 50. High velocity jet 54 delivers a flow of high velocity gas toward each of main engine exhaust outlet 48 and APU exhaust outlet 50. Interactions between the flow of high velocity gases and exhaust gases passing from main engine exhaust outlet 48 and APU exhaust outlet 50 may alter a plume trajectory of exhaust gases and reduce hot gas impingement on surfaces of fuselage 18 and/or areas surrounding aircraft 10. It should be understood that the term “high velocity gas stream” describes a gas stream having a transonic velocity or a supersonic velocity.

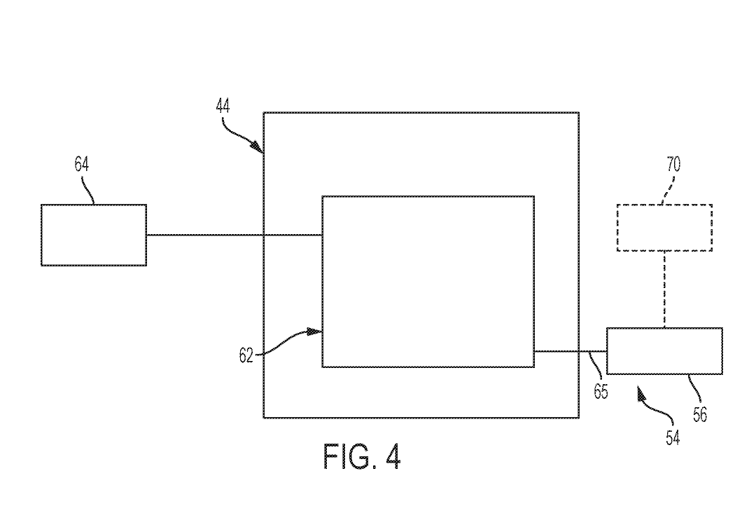

In accordance with an exemplary aspect, high velocity jet 54 is fluidically connected to APU 44 as shown in FIG. 4. More specifically, high velocity jet 54 may be fluidically connected to a compressor portion 62 of APU 44. Compressor portion 62 includes an inlet 64 and an outlet 65 that fluidically connects with outlet nozzle 56 of high velocity jet 54. In accordance with another exemplary embodiment, outlet nozzle 56 may be adjustable and connected to a flight control computer 70. More specifically, high velocity outlet may define a selectively positionable outlet (not separately labeled). Flight control computer 70 may selectively adjust a position of outlet nozzle 56 to adjust a direction of the high velocity gas stream depending on flight regimes, flight characteristics, ground conditions, and the like.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An aircraft comprising:
a fuselage including one or more surfaces;
at least one engine mounted in the fuselage, the at least one engine including an exhaust outlet; and
a high velocity jet arranged at the fuselage forward of the exhaust outlet, the high velocity jet being positioned to direct a stream of high velocity gases toward the exhaust outlet redirecting exhaust gases from the one or more surfaces.

2. The aircraft according to claim 1, wherein the stream of high velocity gases comprises a jet of exhaust gases having one of a transonic velocity and a supersonic velocity.

3. The aircraft according to claim 1, wherein the at least one engine includes a first engine having a first exhaust outlet and a second engine having a second exhaust outlet.

4. The aircraft according to claim 3, wherein the high velocity jet is arranged forward of and below the first exhaust outlet and forward of the second exhaust outlet.

5. The aircraft according to claim 3, wherein the second engine comprises an auxiliary power unit (APU) and the second exhaust outlet comprises an APU exhaust outlet.

6. The aircraft according to claim 5, wherein the APU includes a compressor portion, the high velocity jet being fluidically connected to the compressor portion.

7. The aircraft according to claim 1, wherein the high velocity jet includes a selectively positionable outlet configured to selectively adjust a direction of the stream of high velocity gases.

8. A method of redirecting exhaust gases passing from at least one engine of an aircraft comprising:
directing a flow of high velocity gases to a high velocity jet supported at a fuselage of the aircraft forward of an exhaust outlet of the at least one engine;
guiding the flow of high velocity gases from the high velocity jet toward the exhaust gases passing from the exhaust outlet of the at least one engine; and
redirecting the exhaust gases away from surfaces of the fuselage with the flow of high velocity gases.

9. The method of claim 8, further comprising:
generating the flow of high velocity gases in the aircraft.

10. The method of claim 9, wherein generating the flow of high velocity gases in the aircraft includes operating an auxiliary power unit (APU) compressor.

11. The method of claim 8, wherein directing the flow of high velocity gases toward the exhaust outlet includes guiding the exhaust gases from the high velocity jet toward a first exhaust outlet and a second exhaust outlet.

12. The method of claim 11, wherein guiding the flow of high velocity gases toward the first exhaust outlet and the second exhaust outlet includes guiding the flow of high velocity gases toward a main engine exhaust outlet and an auxiliary power unit (APU) exhaust outlet.

13. The method of claim 12, wherein guiding the flow of high velocity gases includes directing the flow of high velocity gases upwardly toward the main engine exhaust outlet and rearwardly toward the APU exhaust outlet.

14. The method of claim 8, further comprising: selectively repositioning an outlet of the high velocity jet.

15. The method of claim 8, wherein directing the flow of high velocity gases to the high velocity jet includes directing a flow of gases having one of a transonic velocity and a high velocity gases toward the high velocity jet.
